(19) United States
(12) Patent Application Publication
(10) Pub. No.: US 2007/0035620 A1
(43) Pub. Date: Feb. 15, 2007

(54) PRINTING SYSTEM FOR ENDOSCOPE

(75) Inventor: Noriko Ota, Tokyo (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/462,423

(22) Filed: Aug. 4, 2006

(30) Foreign Application Priority Data
Aug. 9, 2005 (JP) P2005-230573

(51) Int. Cl. H04N 7/18

(52) U.S. Cl. 348/65

(57) ABSTRACT

An image printing system for an endoscope includes a printer, a print commander, a printer-information memory, a timer, and an alarm. The printer prints an image, and the print commander commands the printer to print the image. The printer-information memory stores printer-information, including time-information that represents a required-time-period for the printer to print the image on a substrate. The timer measures an elapsed time from when printing of the image starts. The alarm alerts that the printer can not print a new image if the elapsed time until when the print commander commands the printer to print the new image is shorter than the required-time-period.

### BACKGROUND OF THE INVENTION

1. Field of the Invention

The present invention relates to an image printing system, especially to an image printing system used in an endoscope device.

2. Description of the Related Art

In an endoscope, a dye sublimation printer, which heats and sublimates inks for printing subject images based on generated image data, is widely used. Dye sublimation printers generally spend much time for printing, although they can print fine-grained images by setting ink densities closely due to heat control.

In printers used with an endoscope, image data transferred from the endoscope is temporarily stored in a memory until printing ends. Usually, in endoscope operations, a plurality of subject images are printed on a printing paper, because images of subjects in slightly different positions are required to be compared to each other, and for other reasons.

When a plurality of subject images are printed on a single printing paper sheet by a dye sublimation printer, the time for the printing operation is long. In such a case, when new image data are transferred to the printer and printing is commanded, newly commanded images may not be printed. Further, when an operator commands printing many images while observing a subject with an endoscope, the operator may quit observing a subject without noticing that some commanded images have not been printed. In such a case, finding the non-printed images becomes required, and efficiency of operation may be decreased.

On the other hand, recently, a general-purpose computer that can efficiently handle interactive data communications with a connected device, such as a printer, has been widely used. Such a computer can not only transfer huge amount of image data to a connected printer, but also can receive signals from the printer (for example, signals representing that there is an image that the printer can not print, although image data thereof are transferred from the computer to the printer). In such a case, the computer can temporarily store the image data of an image that can not be printed, and can re-transfer the image data later again to the printer, so that the printing operation can be carried out efficiently.

However, there are some restrictions on selecting medical instruments to be used, including an endoscope, because they generally need to be officially approved in terms of safety and hygiene Therefore, in an endoscope system, the above mentioned superior computer may not always be introduced; that is, a printer is not always connected to an endoscope that can handle interactive data communications efficiently with a connected printer. When such an endoscope and a printer are used in an endoscope system, efficiency of operation may be decreased.

### SUMMARY OF THE INVENTION

Therefore, an objective of the present invention is to provide an image printing system for an endoscope that alerts immediately if printing of a commanded image is not carried out, and which enables efficient operation.

An image printing system for an endoscope, according to the present invention, includes a printer, a print commander, a printer-information memory, a timer, and an alarm. The printer prints an image, and the print commander commands the printer to print the image. The printer-information memory stores printer-information, including time-information that represents a required-time-period for the printer to print the image on a substrate. The timer measures an elapsed time from when printing of the image starts. The alarm alerts that the printer can not print a new image if the elapsed time until when the print commander commands the printer to print the new image is shorter than the required-time-period.

An endoscope system, according to the present invention, includes a subject image generator, a printer, a print commander, a printer-information memory, a timer, and an alarm. The subject image generator generates an image data of a subject. The printer prints an image of the subject, and the print commander commands the printer to print the image. The printer-information memory stores printer-information, including time-information that represents a required-time-period for the printer to print the image on a substrate. The timer measures an elapsed time from when printing of the image starts. The alarm alerts that the printer can not print a new image if the elapsed time until when the print commander commands the printer to print the new image is shorter than the required-time-period.

### BRIEF DESCRIPTION OF THE DRAWINGS

The present invention will be better understood from the description of the preferred embodiment of the invention set forth below, together with the accompanying drawings, in which:

FIG. 1 is a block diagram of an endoscope system of the embodiment;

FIG. 2 is a view representing an example of a subject images printed by a printer; and

FIG. 3 is a flowchart of a print control routine representing print control in an endoscope system.

### DESCRIPTION OF THE PREFERRED EMBODIMENT

Hereinafter, the preferred embodiment of the present invention is described with reference to the attached drawings.

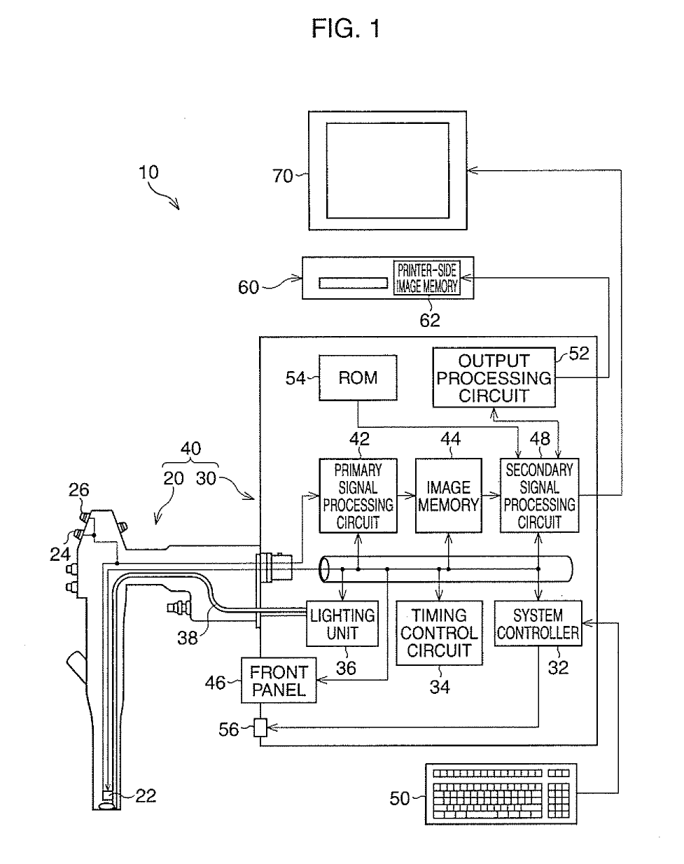

As shown in FIG. 1, an endoscope system 10 includes an endoscope 40, comprising a video scope 20 and a processor 30. The video scope 20 is used for photographing inside a body cavity, The processor 30 processes image signals transferred from the video scope 20. To the processor 30, a keyboard 50 for inputting order signals and other information, a dye sublimation type printer 60 for printing a subject image and other documents, and a monitor 70 for displaying a subject image are connected. In the endoscope system 10, printers other than the printer 60 can be also used.

In the processor 30, a system controller 32 for controlling the entirety of the processor 30, a timing control circuit 34 for controlling signal processing timing in other circuits, a lighting unit 36, and other components are provided. A light source (not shown) in the lighting unit 36 emits illuminating light under the control of the system controller 32. The illuminating light enters a light guide 38 after its amount is adjusted. The illuminating light passes through the light guide 38, and is emitted to a body cavity from the end of the video scope 20.

The illuminating light reflected on a subject reaches a light-receiving surface of the CCD 22, then image signals representing a subject are generated by the CCD 22. Further, the luminance signal Y and the color-difference signals Cb and Cr are generated by processing the image signals. The luminance signal Y and the color-difference signals Cb and Cr are transferred to a primary signal processing circuit 42, and are stored in an image memory 44 after further processes are carried out in the primary signal processing circuit 42.

Image data, including the luminance signal Y and color-difference signals Cb and Cr, are output from the image memory 44 to the monitor 70 via a secondary signal processing circuit 48. As a result, a real-time moving image of a subject is displayed on the monitor 70.

A freeze button 24 is provided on the video scope 20. When the freeze button 24 is depressed while a moving image is displayed on the monitor 70, signals for generating a still image are transferred to the system controller 32, and image data of a still image are generated. The generated image data of a still image are stored in the image memory 44, and transferred to the secondary signal processing circuit 48. In the secondary signal processing circuit 48, predetermined processes are carried out on the image data, and the image data are transferred to the monitor 70. As a result, a still image is displayed on the monitor 70.

Further, a copy button 26 is provided on the video scope 20 adjacent to the freeze button 24. The copy button 26 is used for specifying an image to be printed by the printer 60, and is used for commanding the printing thereof. That is, when the copy button 26 is depressed while a moving image is displayed on the monitor 70, command signals to command the printer 60 to print a still image of the subject displayed when the copy button 26 is depressed, are transferred to the system controller 32. As a result, image data of the still image specified by the copy button 26 are generated, and the generated image data of the still image are transferred to the printer 60 via the secondary signal processing circuit 48 and the output processing circuit 52. Then, the still image is printed.

Note that images stored in the image memory 44 when observation of subjects end can be printed by the operations of the keyboard 50 or a print button (not shown) provided on the surface of the printer 60. Further, a still image generated and stored by the depression of the freeze button 24 can be also printed by depressing the copy button 26.

In the printer 60, a printer-side image memory 62 for temporarily storing image data transferred from the output processing circuit 52 is provided. When a subject image based on the image data stored in the printer-side image memory 62 is printed on a printing paper sheet (a substrate), the image data of the printed subject image are automatically deleted from the printer-side image memory 62, and image data newly transferred to the printer-side image memory 62 are stored, as explained below. In this manner, printing a subject image represented by the image data, and transferring and deleting the image data, may be repeated.

Note that when the printer 60 can not print a subject image commanded to be printed, an alert message representing that the printer 60 can not print the commanded image, and an audio alarm device 56, provided adjacent to a front panel 46, emits a warning sound under the control of the system controller 32, as explained below.

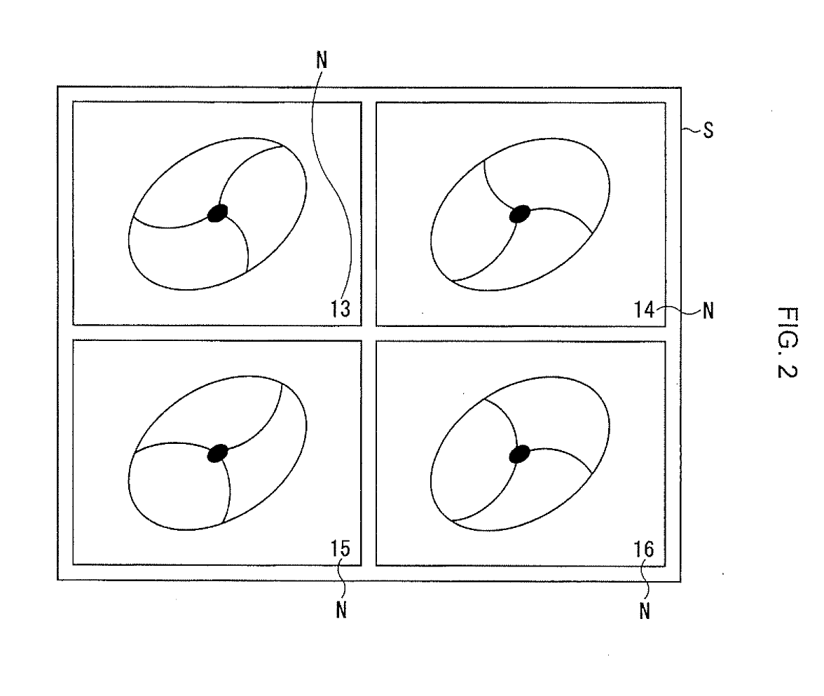

The printer 60 can print subject images in each of a plurality of divided areas of a printing area on a single printing paper sheet S (see FIG. 2). A print-image-number, that is, a maximum number of divided areas, and a maximum number of images printed on a single printing paper sheet S, can be selected from the choices previously set according to printers by the input operations of the keyboard 50. For example, in the printer 60, if “four” is set as the print-image-number, then up to four subject images can be printed on a single printing paper sheet S, as shown in FIG. 2.

Note that in the printer 60, setting the print-image-number to “one” is also possible; that is, it is possible to set only one subject image to be printed on a single printing paper sheet S, without dividing the printing area. Further, setting the print-image-number to “two”, “eight”, or another number is also possible, in order to divide a printing area into two, eight, or another number of divided areas. An image-identification-number “N” is assigned to each of the divided printing areas to identify subject images that are specified and commanded to be printed. Each image-identification-number “N” is automatically assigned in the order of print commanding, displayed on the monitor 70 by each image-identification-number being superimposed on a subject image, and printed on the edge of each subject image when the copy button 26 is depressed.

Printer-information, including the print-image-number, is stored in a data memory (not shown) provided in the output processing circuit 52. The printer-information includes a required-time-period of the printer 60; that is, the time period required for the printer 60 to print the print-image-number of the images on a printing paper sheet S. The required-time-period is a value unique mainly to a printer and to each print-image-number; therefore, the required-time-period is set and stored for each kind of printer and for each print-image-number.

The printer-information is stored in the data memory not only for the printer 60, but also for other kinds of printers. Therefore, a plurality of printers can be selectively used in the endoscope system 10 by connecting one of them to the processor 30. Note that the required-time-period can vary according to the image to be printed, especially with respect to the quality of the image, therefore, the longest time period required for printing is calculated beforehand and set as the required-time-period.

When the print-image-number is set to “four”, and the copy button 26 is depressed four times, four subject images to be printed are specified, and the four subject images are stored in the printer-side image memory 62; thus, the printer 60 automatically prints the four subject images, as exemplified in FIG. 2. If while the printer 60 is printing subject images, the copy button 26 is then depressed, the printer 60 can not print the subject image specified last. The reason for that the image data of the image that is specified while the printer 60 is printing can not be stored in the printer-side image memory 62.

Therefore, when the printing by the printer 60 starts, a system clock (not shown) provided in the timing control circuit 34 measures an elapsed time from when the printing starts. Then, when the copy button 26 is depressed, an elapsed time from the starting time of printing to the time when the copy button 26 is depressed, and a predetermined required-time-period read from the data memory of the output processing circuit 52, are compared by the system controller 32.

As a result of the comparison, in the case when the elapsed time from the print starting time to the depression time of the copy button 26 is shorter than the required-time-period (that is, in the case when the copy button 26 is depressed while the printer 60 is printing), an alert message representing that the printer 60 can not print the commanded image is displayed on the monitor 70, and the audio alarm device 56 emits a warning sound.

For the alert message display, character-information previously stored in a ROM 54 is read by the secondary signal processing circuit 48 (see FIG. 1). Then, the alert message is superimposed with the image-identification-number “N” on a subject image on the monitor 70, based on the character-information. Therefore, an operator can immediately understand which subject image can not be printed, regardless of the print command.

Note that when the elapsed time from the print starting time to the depression time of the copy button 26 is longer than the required-time-period, the image data of the subject image specified by the depression of the copy button 26 are stored in the printer-side image memory 62 for the next printing.

The printer 60 automatically starts printing when the number of subject images to be printed is equal to the set print-image-number; therefore, ordinarily, a print-image-number of subject images are printed on the printing paper sheet S, as exemplified in FIG. 2.

However, an operator may sometimes choose to start printing when the number of subject images to be printed is smaller than the set print-image-number; for example, after observing a series of subjects. In such a case, printing a smaller number of subject images than the set print-image-number is possible by command entry operations of the keyboard 50, or by depressing a print switch (not shown) provided on the printer 60, for transferring command signals for commanding printing to the output processing circuit 52 via the secondary signal processing circuit 48. Then, the printing of a smaller number of subject images than the print-image-number is carried out.

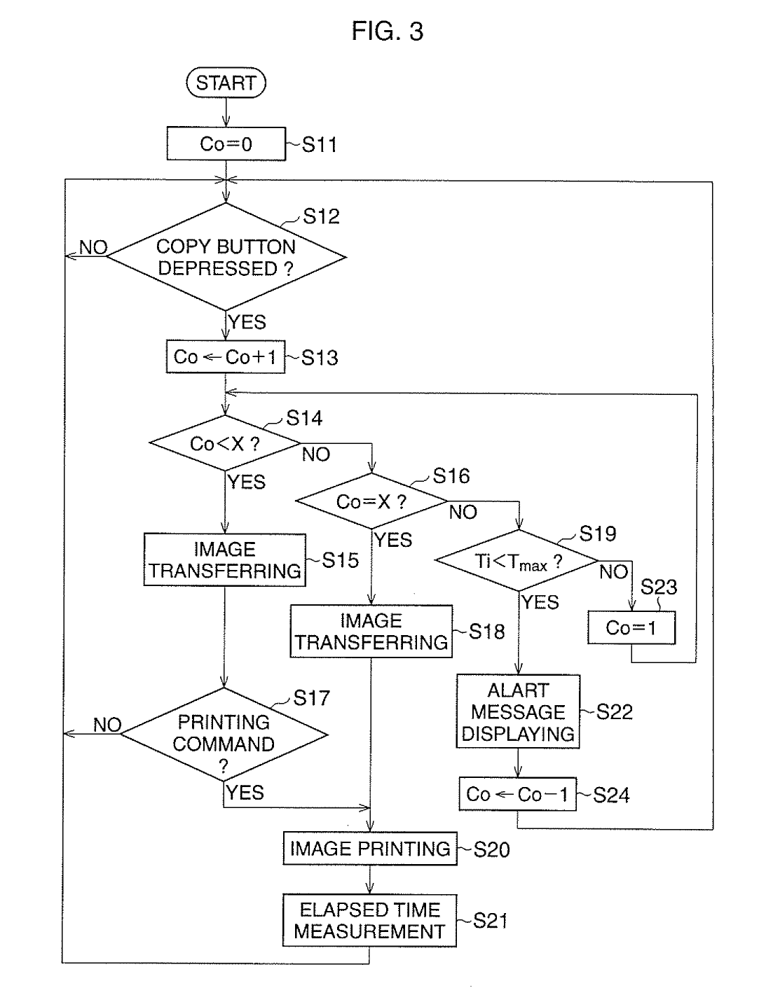

A print control routine (see FIG. 3) starts when the endoscope system 10 starts. At step S11, a subject image index “Co” is set to the initial value “0”, and the process proceeds to step S12. The subject image index “Co” represents a printing order of images to be printed on a single printing paper sheet S. At step S12, it is determined whether the copy button 26 is turned on or not; that is, whether the copy button 26 is depressed and the printing of an image is being commanded or not. When it is determined that the copy button 26 is turned on and printing is commanded, the process proceeds to step S13. At step S13, the subject image index “Co” is incremented by “1”, and the process proceeds to step S14.

At step S14, it is determined whether the subject image index “Co” is smaller than the set print-image-number “X” or not by the system controller 32. When it is determined that the subject image index “Co” is smaller than the print-image-number “X”, the process proceeds to step S15, and when it is determined that the subject image index “Co” is not smaller than the print-image-number “X”, the process proceeds to step S16.

At step S15, image data of the subject image specified at step S12 are transferred from the output processing circuit 52 to the printer-side image memory 62 in the printer 60, and the process proceeds to step S17. At step S17, whether printing is commanded or not by the operations of the keyboard 50 or the print switch is determined by the output processing circuit 52. When it is determined that printing is commanded, the process proceeds to step S20, and when it is not determined that printing is commanded, the process returns to step S12.

At step S16, it is determined whether the subject image index “Co” is equal to the print-image-number “X” or not. When it is determined that the subject image index “Co” is equal to the print-image-number “X”, the process proceeds to step S18, and when it is determined that the subject image index “Co” is not equal to the print-image-number “X” (that is, that the subject image index “Co” is higher than the print-image-number “X”), the process proceeds to step S19.

At step S18, image data of the subject image specified at step S12 are transferred from the output processing circuit 52 to the printer-side image memory 62, and the process proceeds to step S20. At step S20, a subject image represented by the image data temporarily stored in the printer-side image memory 62 is printed, and the process proceeds to step S21. At step S21, an elapsed time “Ti” from the starting time of the printing at step S20 is reset by the timing control circuit 34, and measurement of the elapsed time “Ti” starts.

That is, at step S21, if the elapsed time “Ti” has already been measured, the elapsed time “Ti” is reset to “0”, and continues to be measured. On the other hand, if the elapsed time “Ti” has not been measured, then measurement of the elapsed time “Ti” newly starts. After measuring the elapsed time “Ti” is continued or newly started at step S21, the process returns to step S12.

As explained above, in the print control routine, when the subject image index “Co” is equal to the print-image-number “X” (that is, when an image specified by the depression of the copy button 26 to be printed is the last printable image on a single printing sheet S), the printer 60 automatically starts printing (steps S16, S18, and S20). Further, if the number of images print-commanded by the copy button 26 is lower than the print-image-number, and if printing is commanded by the print switch or so on (steps S14, S15, and S17), then printing an image starts (step S20).

At step S19, the elapsed time “Ti” that has already been started to be measured at step S21 is read by the system controller 32 based on the kind of printer and the set print-image-number “X”. Then, it is determined whether the read elapsed time “Ti” is shorter than the required-time-period “Tmax” or not. When it is determined that the elapsed time “Ti” is shorter than the required-time-period “Tmax” (that is, when specifying an image to be printed at step S12 is carried out while the printer 60 is printing, and printing the specified image can not be carried out), the process proceeds to step S22. On the other hand, when it is determined that the elapsed time “Ti” is longer than or equal to the required-time-period “Tmax”, the process proceeds to step S23.

At step S22, an alert message is displayed on the monitor 70, and a warning sound is emitted, and the process proceeds to step S24. At step S24, the subject image index “Co” is decremented by “1” because the image specified at step S12 is not printed although the copy button 26 is turned on, and the process returns to step S12.

On the other hand, at step S23, the subject image index “Co” is set to “1” to cause the image specified and print-commanded at step S12 to be the first image on a new printing paper sheet S. The reason is that it is clear that the printer-side image memory 62 can receive the image data of the image specified and print-commanded at step S12, and that the printing of images print-commanded before step S12 has already been finished. Then, the process returns to step S14.

As explained above, when the number of images to be printed is higher than the print-image-number “X”, an operator can be warned that the image specified and print-commanded after print-image-number “X” during the required-time-period “Tmax” can not be printed (step S22).

In the endoscope system 10 of the embodiment, as explained above, when the number of images to be printed is equal to the print-image-number, the printer 60 automatically starts printing. When the number of images to be printed is higher than the print-image-number, the endoscope system 10 can immediately warn an operator that the image specified and print-commanded while the printer 60 is printing can not be printed.

Therefore, an operator can know just after the print command if the subject image print-commanded can not be printed, so that the re-observation needed only for finding the part of the subject whose image has failed to be printed after observing a series of subjects can be avoided, even if the processor 30 can not handle interactive communications with the printer 60 (that is, even if the processor 30 can not receive signals representing that there is an image that the printer 60 can not print from the printer 60), and can not store image data thereof. In the endoscope system 10, therefore, efficient subject observation can be carried out, and inspection time can be shortened.

Note that an image printing system is not limited to the endoscope system 10. For example, a computer for specifying an image to be printed by the printer 60 can be used instead of the endoscope 40. Further, a printer adopted in an image printing system is not limited to the dye sublimation printer 60, which requires a relatively long time for printing. For example, an inkjet printer can also be used.

This invention is not limited to that described in the preferred embodiment; namely, various improvements and changes may be made to the present invention without departing from the spirit and scope thereof.

The present disclosure relates to subject matter contained in Japanese Patent Application No. 2005-230573 (filed on Aug. 9, 2005), which is expressly incorporated herein, by reference, in its entirety.

1. An image printing system for an endoscope, comprising;
a printer that prints an image;
a print commander that commands said printer to print said image;
a printer-information memory that stores printer-information, including time-information that represents a required-time-period for said printer to print said image on a substrate;
a timer that measures an elapsed time from when printing of said image starts; and
an alarm that alerts that said printer can not print a new image if said elapsed time until when said print commander commands said printer to print said new image is shorter than said required-time-period.

2. The image printing system according to claim 1, wherein said printer comprises an image memory that stores image data of said image commanded by said print commander, and an image deleter that deletes said image data after said printer prints said image.

3. The image printing system according to claim 1, wherein said printer comprises a print-image-number setter that sets a print-image-number that is a maximum number of images printed on a single said substrate, and wherein said print-image-number is included in said printer-information.

4. The image printing system according to claim 3, wherein said printer-information memory stores said required-time-period for said printer to print said print-image-number of said images on said single substrate, as said printer-information.

5. The image printing system according to claim 3, further comprising a number judge that determines whether a number of images commanded by said print commander to be printed is equal to said print-image-number or not, and when said number judge determines that said number of images is equal to said print-image-number, said printer automatically prints said images commanded by said print commander.

6. The image printing system according to claim 5, wherein said printer can print said images commanded by said print commander based on instructions from a user, regardless of a result of determination of said number judge.

7. The image printing system according to claim 1, further comprising a monitor to display said image.

8. The image printing system according to claim 7, wherein said monitor is included in said alarm, and said monitor can further display an alert message representing that said printer can not print said new image.

9. The image printing system according to claim 1, wherein said printer is a dye sublimation printer.

10. An endoscope system comprising;
a subject image generator that generates an image data of a subject;
a printer that prints an image of said subject;
a print commander that commands said printer to print said image;
a printer-information memory that stores printer-information, including time-information that represents a required-time-period for said printer to print said image on a substrate;
a timer that measures an elapsed time from when printing of said image starts; and
an alarm that alerts that said printer can not print a new image if said elapsed time until when said print commander commands said printer to print said new image is shorter than said required-time-period.

11. The endoscope system according to claim 10, wherein said printer-information memory can store said printer-information for a plurality of said printers, so that each said printer can be used.
